(19) United States
(12) Patent Application Publication
(10) Pub. No.: US 2004/0029043 A1
(43) Pub. Date: Feb. 12, 2004

(54) Process for producing circuit substrates

(76) Inventors: Yasuhiro Wakizaka, Kanagawa (JP); Daisuke Uchida, Kanagawa (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/381,055

(22) PCT Filed: Sep. 27, 2001
(86) PCT No.: PCT/JP01/08455

(51) Int. Cl. G03C 1/73

(52) U.S. Cl. 430/280.1; 430/281.1; 264/400

(57) ABSTRACT

A curable composition contains an insulating resin such as an alicyclic olefin polymer or an aromatic polyether polymer, a nitrogen-type curing agent such as a 1,3-diallyl-5-glycidylisocyanurate, and an ultraviolet-ray absorbing agent such as a 2-[2-hydroxy-3,5-bis(α,α-dimethylbenzyl)phenyl]benzotriazole. A film is obtained from the curable composition by a solution casting method, is laminated on an inner-layer board and is cured to obtain a multi-layer circuit board.

### TECHNICAL FIELD

The present invention relates to a method of producing circuit boards. More specifically, the invention relates to a method of producing multi-layer circuit boards by using an ultraviolet-ray laser beam featuring a short working time for forming holes and which hardly develops cracks.

### BACKGROUND ART

The technology for very densely mounting electronic circuits have been developed accompanying the modern trend toward producing electronic devices in small sizes. The known mounting technology of this kind uses a multi-layer board having through-holes and blind via-holes. The through holes and blind via-holes are formed in the multi-layer board by forming, in the main body of the multi-layer board, working holes for forming through holes and working holes for forming blind via-holes, and forming an electrically conducting layer on the inner peripheral surfaces of the working holes and on the surface of the layer.

Previously, the working holes for forming through-holes had been formed in the multi-layer boards of this kind by drilling the main body of the multi-layer board.

On the other hand, the working holes for forming blind via-holes can be formed by a method in which an adhesive layer is applied onto a copper layer except those portions where there are to be formed working holes for forming the blind via-holes, a polyimide layer is printed on the adhesive layer, an adhesive layer is applied onto the polyimide layer except the portions where there are to be formed working holes for forming the blind via-holes and, then, a copper layer is printed onto the adhesive layer (Japanese Unexamined Patent Publication (Kokai) No. 3-272195) and a method in which through holes are formed in the laminate plate of an insulating layer and an electrically conducting layer which are laminated together via an adhesive layer in order to form inner surfaces of the working holes for forming the blind via-holes, and a copper layer is printed on the insulating layer so as to close the openings of the through holes on the side of the insulating layer (Japanese Unexamined Patent Publication (Kokai) No. 8-272195).

According to the method based on the drilling and printing, however, it is difficult to carry out the fine working (micro working) making it no longer possible to cope with the modern demand for high-density mounting.

Under such circumstances, there has been proposed, as a fine-working method, a method which forms via-holes and the like holes by the irradiation with an ultraviolet-ray laser beam (e.g., UV-YAG laser beam) or a carbonic acid gas laser beam (Japanese Unexamined Patent Publication (Kokai) No. 11-342485).

In actually forming the holes by a laser beam and, particularly, by an ultraviolet-ray laser beam, however, the laser beam must be projected for extended periods of time due to its poor ability to remove the insulating layer. There can be employed a laser beam of a large output to shorten the time for laser irradiation but, in this case, cracks easily develop in the insulating layer and the edges of the holes swell to deteriorate the precision of the thickness of the multi-layer circuit board.

### DISCLOSURE OF THE INVENTION

It is an object of the present invention to provide a method of producing multi-layer circuit boards capable of suppressing the occurrence of cracks in the insulating layer even when the holes are formed in short periods of time by using an ultraviolet-ray laser beam.

The present inventors have conducted a keen study to achieve the above object, have discovered the fact that the holes can be formed within short periods of time by irradiating, with an ultraviolet-ray laser beam, an insulating layer obtained by curing a curable composition containing an insulating resin and an ultraviolet-ray absorbing agent, that a multi-layer circuit board substantially without cracks can be obtained maintaining a favorable shape of the holes, and have completed the present invention based on these discoveries.

According to the present invention, there is provided a method of producing circuit boards by laminating, on an inner-layer board, a curable composition containing an insulating resin and an ultraviolet-ray absorbing agent, curing the composition, and forming holes in the cured composition by irradiation with an ultraviolet-ray laser beam.

### BEST MODE FOR CARRYING OUT THE INVENTION

A method of producing circuit boards of the present invention comprises the steps of laminating, on an inner-layer board, a curable composition containing an insulating resin and an ultraviolet-ray absorbing agent, curing the composition, and forming holes in the cured composition by irradiation with an ultraviolet-ray laser beam.

The insulating resin that constitutes the curable composition of the invention is a known insulating resin used for forming an electrically insulating layer. As the resin, there can be exemplified an epoxy resin, a maleimide resin, a (meth)acrylic resin, a diallyl phthalate resin, a triazine resin, an alicyclic olefin polymer, an aromatic polyether polymer, a benzocyclobutene polymer, a cyanate ester polymer, a liquid crystalline polymer and a polyimide. Among them, it is desired to use an alicyclic olefin polymer, an aromatic polyether polymer, a benzocyclobutene polymer, a cyanate ester polymer or a polyimide, and it is particularly desired to use an alicyclic olefin polymer or an aromatic polyether polymer, and it is very desired to use an alicyclic olefin polymer. In addition to these insulating resins, there can be used a liquid crystalline polymer as a preferred insulating resin. As the liquid crystalline polymer, there can be preferably used such thermoplastic liquid crystalline polymers as a polymer of an aromatic or aliphatic dihydroxy compound, a polymer of an aromatic or aliphatic dicarboxylic acid, a polymer of an aromatic hydroxycarboxylic acid, or a polymer of aromatic diamine, aromatic hydroxyamine or aromatic aminocarboxylic acid.

The alicyclic olefin polymer that constitutes the curable composition is a polymer of an olefin having an alicyclic structure. As the alicyclic structure, there can be exemplified a cycloalkane structure and a cycloalkene structure. From the standpoint of mechanical strength and heat resistance, however, the cycloalkane structure is preferred. As the alicyclic structure, further, there can be exemplified a monocyclic structure and a polycyclic structure (condensed polycyclic structure, crosslinked cyclic structure, or polycyclic structure of a combination thereof). There is no particular limitation on the number of carbon atoms constituting the alicyclic structure. Usually, however, the number of carbon atoms is in a range of from 4 to 30, preferably, from 5 to 20 and, more preferably, from 5 to 15. By using an alicyclic olefin polymer having carbon atoms in a number lying in this range, there is obtained a favorable curable composition having mechanical strength, heat resistance and moldability which are balanced to a high degree. Further, the alicyclic olefin polymer used in the present invention is usually a thermoplastic one.

The alicyclic olefin polymer, usually, has recurring units stemming from an olefin having the alicyclic structure (hereinafter often referred to as an alicyclic olefin). The ratio of the recurring units stemming from the alicyclic olefin in the alicyclic olefin polymer can be suitably selected depending upon the use, and is, usually, from 30 to 100% by weight, preferably, from 50 to 100% by weight and, more preferably, from 70 to 100% by weight. When the ratio of the recurring units stemming from the alicyclic olefin is too small, the heat resistance becomes poor, which is not desirable.

The alicyclic olefin polymer used in the present invention preferably has a polar group. As the polar group, there can be exemplified a hydroxyl group, a carboxyl group, an alkoxyl group, an epoxy group, a glycidyl group, an oxycarbonyl group, a carbonyl group, an amino group, an ester group and a carboxylic anhydride group. Among them, a carboxyl group or a carboxylic anhydride is particularly desired.

The alicyclic olefin polymer is obtained, usually, by subjecting an alicyclic olefin to the additional polymerization or the ring-opening polymerization, and, as required, hydrogenating the unsaturated bonding portions or addition-polymerizing an aromatic olefin and, then, hydrogenating the aromatic ring portion of the polymer. Further, the alicyclic olefin polymer having a polar group is obtained by, for example, (1) introducing a compound having a polar group into the alicyclic olefin polymer by a modified reaction, (2) (co)polymerizing a monomer containing a polar group such as an ester group or a hydroxyl group as a (co)polymerizable component, or (3) (co)polymerizing a monomer containing an ester group as a (co)polymerizable component and, then, hydrolyzing the ester group. In the present invention, the one obtained by the method (1) is preferred.

Examples of the alicyclic olefin used for obtaining the alicyclic olefin polymer include norbornene monomers such as bicyclo[2.2.1]-hepto-2-ene (common name: norbornene), 5-methyl-bicyclo[2.2.1]-hepto-2-ene, 5,5,-dimethyl-bicyclo[2.2.1]-hepto-2-ene, 5-ethyl-bicyclo[2.2.1]-hepto-2-ene, 5-butyl-bicyclo[2.2.1]-hepto-2-ene, 5-hexyl-bicyclo[2.2.1]-hepto-2-ene, 5-octyl-bicyclo[2.2.1]-hepto-2-ene, 5-octadecyl-bicyclo[2.2.1]-hepto-2-ene, 5-ethylidene-bicyclo[2.2.1]-hepto-2-ene, 5-methylidene-bicyclo[2.2.1]-hepto-2-ene, 5-vinyl-bicyclo[2.2.1]-hepto-2-ene, 5-propenyl-bicyclo[2.2.1]-hepto-2-ene, 5-methoxycarbonyl-bicyclo[2.2.1]-hepto-2-ene, 5-cyano-bicyclo[2.2.1]-hepto-2-ene, 5-methyl-5-methoxycarbonyl-bicyclo[2.2.1]-hepto-2-ene, 5-ethoxycarbonyl-bicyclo[2.2.1]-hepto-2-ene, bicyclo[2.2.1]-hepto-5-enyl-2-methyl propionate, bicyclo[2.2.1]-hepto-5-enyl-2-methyl octanate, bicyclo[2.2.1]-hepto-2-ene-5,6-dicarboxylic anhydride, 5-hydroxymethylbicyclo[2.2.1]-hepto-2-ene, 5,6-di(hydroxymethyl)-bicyclo[2.2.1]-hepto-2-ene, 5-hydroxy-i-propylbicyclo[2.2.1]-hepto-2-ene, 5,6-dicarboxy-bicyclo[2.2.1]-hepto-2-ene, imide bicyclo[2.2.1]-hepto-2-ene-5,6-dicarboxylate, 5-cyclopentyl-bicyclo[2.2.1]-hepto-2-ene, 5-cyclohexyl-bicyclo[2.2.1]-hepto-2-ene, 5-cyclohexenyl-bicyclo[2.2.1]-hepto-2-ene, 5-phenyl-bicyclo[2.2.1]-hepto-2-ene, tricyclo[4.3.0.1^{2,5}]deca-3,7-diene (common name; dicyclopentadiene), tricyclo[4.3.0.1^{2,5}]deca-3-ene, tricyclo[4.4.0.1^{2,5}]undeca-3,7-diene, tricyclo[4.4.0.1^{2,5}]undeca-3,8-diene, tricyclo[4.4.0.1^{2,5}]undeca-3-ene, tetracyclo[7.4.0.1^{10,13}, 0^{2,7}]-trideca-2,4,6-11-tetraene (another name: 1,4-methano-1,4,4a,9a-tetrahydrofluorene), tetracyclo[8.4.0.1^{11,14}.0^{3,8}]-tetradeca-3,5,7,12-11-tetraene (another name: 1,4-methano-1,4,4a,5,10,10a-hexahydroanthracene), tetracyclo[4.4.0.1^{2,5}.1^{7.10}]-dodeca-3-ene (common name: tetracyclododecene), 8-methyl-tetracyclo[4.4.0.1^{2,5},1^{7,10}]-dodeca-3-ene, 8-ethyl-tetracyclo[4.4.0. 1^{2,5},1^{7,10}]-dodeca-3-ene, 8-methylidene-tetracyclo[4.4.0.1^{2,5}.1^{7,10}]-dodeca-3-ene, 8-ethylidene-tetracyclo[4.4.0.1^{2,5},1^{7,10}]-dodeca-3-ene, 8-vinyl-tetracyclo[4.4.0.1^{2,5},1^{7.10}]-dodeca-3-ene, 8-propenyl-tetracyclo[4.4.0.1^{2,5},1^{7,10}]-dodeca-3-ene, 8-methoxycarbonyl-tetracyclo[4.4.0.1^{2,5},1^{7,10}]-dodeca-3-ene, 8-methyl-8-methoxycarbonyl-tetracyclo[4.4.0.1^{2,5}.1^{7,10}]-dodeca-3-ene, 8-hydroxymethyl-tetracyclo[4.4.0.1^{2,5}.1^{7,10}]-dodeca-3-ene, 8-carboxy-tetracyclo[4.4.0.1^{2,5},1^{7,10}]-dodeca-3-ene, 8-cyclopentyl-tetracyclo[4.4.0.1^{2,5}.1^{7,10}]-dodeca-3-ene, 8-cyclohexyl-tetracyclo[4.4.0.1^{2,5}.1^{7,10}]-dodeca-3-ene, 8-cyclohexenyl-tetracyclo[4.4.0.1^{2,5},1^{7,10}]-dodeca-3-ene, 8-phenyl-tetracyclo[4.4.0.1^{2,5},1^{7,10}]-dodeca-3-ene, pentacyclo[6.5.1.1^{3,6}.0^{2,7}.0^{9,13}]pentadeca-3,10-diene, pentacyclo[7.4.0.1^{3,6}.1^{10,13}.0^{2,7}]-pentadeca-4,11-diene, tetracyclo[6.5.0.1^{2,5}.0^{8,13}]trideca-3,8,10,12-tetraene, and tetracyclo[6.6.0.1^{2,5}.1^{8,13}]tetradeca-3,8,10,12-tetraene; monocyclic cycloalkenes such as cyclobutene, cyclopentene, cyclohexene, 3,4-dimethylcyclopentene, 3-methylcyclohexene, 2-(2methylbuyl)-1-cyclohexene, cyclooctene, 3a,5,6,7a-tetrahydro-4,7-methano-1H-indene and cycloheptene; vinyl-type alicyclic hydrocarbon monomers such as vinylcyclohexene and vinylcyclohexane; and alicyclic conjugated diene monomers such as cyclopentadiene and cyclohexadiene.

As the alicyclic olefin having a polar group, there can be exemplified bicycloheptene derivatives such as 5-hydroxybicyclo[2.2.1]hepto-2-ene, 5-hydroxymethylbicyclo[2.2.1]hepto-2-ene, 5,6-dihydroxymethylbicyclo[2.2.1]hepto-2-ene, 5-hydroxyethoxycarbonylbicyclo[2.2.1]hepto-2-ene, 5-methyl-5-hydroxyethoxycarbonylbicyclo[2.2.1]hepto-2-ene, 5-hydroxybutoxycarbonylbicyclo[2.2.1]hepto-2-ene, 5-hydroxypopoxycarbonylbicyclo[2.2.1]hepto-2-ene and 5-methyl-5-hydroxypropoxycarbonylbicyclo[2.2.1]hepto-2-ene; tetracyclododecene derivatives such as 8-hydroxytetracyclo[4.4.0. 1^{2,5}.1^{7,10}]dodeca-3-ene, 8-hydroxymethyltetracyclo[4.4.0.1^{2,5}.1^{7,10}]dodeca-3-ene, 8,9-hydroxymethyltetracyclo[4.4.0.1^{2,5}.1^{7,10}]dodeca-3-ene, 8-hydroxyethoxycarbonyltetracyclo[4.4.0.1^{2,5}.1^{7,10}]dodeca-3-ene, 8-methyl-8-hydroxyethoxycarbonyltetracyclo[4.4.0.1^{2,5}.1^{7,10}]dodeca-3-ene, 8-hydroxybutoxycarbonyltetracyclo[4.4.0.1^{2.5}.1^{7,10}]dodeca-3-ene, 8-hydroxypropoxycarbonyltetracyclo[4.4.0.1^{2,5}.1^{7,10}]dodeca-3-ene, and 8-methyl-8-hydroxypropoxycarbonyltetracyclo[4.4.0.1^{2,5}.1^{7,10}]dodeca-3-ene; hexacycloheptadecene derivatives such as 11-hydroxyhexacyclo[6.6.1.1^{3,6}.1^{10,13}.0^{2,7}.0^{9,14}]-heptadeca-4-ene, 11-hydroxymethylhexacyclo[6.6.1.1^{3,6}.1^{10,13}.0^{2,7}.0^{9,14}]-heptadeca-4-ene, 11,12-dihydroxymethylhexacyclo[6.6.1.1^{3,6}.1^{10,13}.0^{2,7}.0^{9,14}]-heptadeca-4-ene, 11-hydroxyethoxycarbonylhexacyclo[6.6.1.1^{3,6}.1^{10,13}.0^{2,7}.0^{9,14}]-heptadeca-4-ene, 11-methyl-11-hydroxyethoxycarbonylhexacyclo[6.6.1.1^{3,6}. 1^{10,13}.0^{2,7}.0^{9,14}]-heptadeca-4-ene, 11-hydroxybutoxycarbonylhexacyclo[6.6.1.1^{3,6}.1^{10,13}.0^{2,7}.0^{9,14}]-heptadeca-4-ene, 11-hydroxypropoxycarbonylhexacyclo[6.6.1.1^{3,6}.1^{10,13}.0^{2,7}.0^{9,14}]-heptadeca-4-ene and 11-methyl-11-hydroxypropoxycarbonylhexacyclo[6.6.1.1^{3,6}.1^{10,13}.0^{2,7}.0^{9,14}]-heptadeca-4-ene; bicycloheptene derivatives such as 5-hydroxycarbonylbicyclo[2.2.1]hepto-2-ene, 5-hydroxycarbonylmethylbicyclo[2.2.1]hepto-2-ene, 5,6-dihydroxycarbonylbicyclo[2.2.1]hepto-2-ene, 5-methyl-5-hydroxycarbonylbicyclo[2.2.1]hepto-2-ene, 5-methyl-5,6-dihydroxycarbonylbicyclo[2.2.1]hepto-2-ene and 5-hydroxycarbonyl-5-hydroxycarbonylmethylbicyclo[2.2.1]hepto-2-ene; tetracyclododecene derivatives such as 5-hydroxycarbonyltetracyclo[4.4.0.1^{2,5}.1^{7,10}]dodeca-3-ene, 5-hydroxycarbonylmethyltetracyclo[4.4.0.1^{2,5}.1^{7,10}]dodeca-3-ene, 5,6-dihydroxycarbonyltetracyclo[4.4.0.1^{2,5}.1^{7,10}]dodeca-3-ene, 5-methyl-5-hydroxycarbonyltetracyclo[4.4.0.1^{2.5}.1^{7,10}]dodeca-3-ene, 5-methyl-5,6-dihydroxycarbonyltetracyclo[4.4.0.1^{2,5}.1^{7,10}]dodeca-3-ene, 5-hydroxycarbonyl-5-hydroxycarbonylmethyltetracyclo[4.4.0.1^{2,5}.1^{7,10}]dodeca-3-ene, 8-hydroxycarbonyltetracyclo[4.4.0.1^{2,5}.1^{7,10}]dodeca-3-ene, 8-hydroxycarbonylmethyltetracyclo[4.4.0.1^{2,5}.1^{7,10}]dodeca-3-ene, 8,9-dihydroxycarbonyltetracyclo[4.4.0.1^{2,5}.1^{7,10}]dodeca-3-ene, 8-methyl-8-hydroxycarbonyltetracyclo[4.4.0.1^{2,5}.1^{7,10}]dodeca-3-ene, 8-methyl-8,9-dihydroxycarbonyltetracyclo[4.4.0.1^{2,5}.1^{7,10}]dodeca-3-ene and 8-hydroxycarbonyl-8-hydroxycarbonylmethyltetracyclo[4.4.0.1^{2,5}.1^{7,10}]dodeca-3-ene; and hexacycloheptadecene derivatives such as 11-hydroxycarbonylhexacyclo[6.6.1.1^{3,6}.1^{10,13}.0^{2,7}.0^{9,14}]-heptadeca-4-ene, 11-hydroxycarbonylmethylhexacyclo[6.6.1.1^{3,6}.1^{10,13}.0^{2,7}.0^{9,14}]-heptadeca-4-ene, 11,12-dihydroxycarbonylhexacyclo[6.6.1.1^{3,6}.1^{10,13}.0^{2,7}.0^{9,14}]-heptadeca-4-ene, 11-methyl-11-hydroxycarbonylhexacyclo[6.6.1.1^{3,6}.1^{10,13}.0^{2,7}.0^{9,14}]-heptadeca-4-ene, 11-methyl-11,12-dihydroxycarbonylhexacyclo[6.6.1.1^{3,6}.1^{10,13}.0^{2,7}.0^{9,14}]-heptadeca-4-ene and 11-hydroxycarbonyl-11-hydroxycarbonylmethylhexacyclo[6.6.1.1^{3,6}.1^{10,13}.0^{2,7}.0^{9,14}]-heptadeca-4-ene.

As the aromatic olefin, there can be exemplified a styrene, an α-styrene and a divinylbenzene.

The alicyclic olefin and/or the aromatic olefin can be used in a single kind or in a combination of two or more kinds.

The alicyclic olefin polymer may be the one obtained by copolymerizing the alicyclic olefin and/or the aromatic olefin with a monomer which is copolymerizable therewith.

As the monomer copolymerizable with the alicyclic olefin or the aromatic olefin, there can be exemplified ethylenes orα-olefins with 2 to 20 carbon atoms, such as ethylene, propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene and 1-eicosene; and nonconjugated dienes such as 1,4-hexadiene, 4-methyl-1,4-hexadiene, 5-methyl-1,4-hexadiene and 1,7-octadiene. These monomers may be used in a single kind or in a combination of two or more kinds.

There is no particular limitation on the method of polymerizing the alicyclic olefin and/or the aromatic olefin or on the hydrogenation method thereof, and any known method may be employed.

As the alicyclic olefin polymer, there can be exemplified a ring-opened polymer of a norbornene monomer and a hydrogenated product thereof, an addition polymer of a norbornene monomer, an addition polymer of a norbornene monomer and a vinyl compound, a monocyclic cycloalkene polymer, an alicyclic conjugated diene polymer, a vinyl-type alicyclic hydrocarbon polymer and a hydrogenated product thereof, and an arocyclic hydrogenated product of an aromatic olefin polymer. Among them, it is desired to use the ring-opened polymer of the norbornene monomer and the hydrogenated product thereof, the addition polymer of the norbornene monomer, the addition polymer of the norbornene monomer and the vinyl compound, and the arocyclic hydrogenated product of the aromatic olefin polymer. In particular, it is desired to use a hydrogenated product of the ring-opened polymer of the norbornene monomer. The alicyclic olefin polymers may be used in a single kind or in a combination of two or more kinds.

There is no particular limitation on the molecular weight of the alicyclic olefin polymer. The molecular weight of the alicyclic olefin polymer is usually from 1,000 to 1,000,000, preferably, from 5,000 to 500,000 and, more preferably, from 10,000 to 250,000 in terms of the weight average molecular weight (Mw) calculated as a polystyrene measured by the gel permeation chromatography (GPC) by using cyclohexane or toluene as a solvent. When the weight average molecular weight (Mw) of the alicyclic olefin polymer lies within this range, the heat resistance and smoothness of the surface of the molded article are balanced, which is desirable.

The molecular weight distribution of the alicyclic olefin polymer is, usually, not larger than 5, preferably, not larger than 4 and, more preferably, not larger than 3 in terms of a ratio (Mw/Mn) of the weight average molecular weight (Mw) and the number average molecular weight (Mn) measured by the GPC by using cyclohexane or toluene as a solvent.

The ranges of the weight average molecular weight (Mw) and the molecular weight distribution (Mw/Mn) and the measurement thereof are favorably adapted to the norbornene polymers, but are not in no way limited thereto only. In the case of the alicyclic olefin polymers of which the weight average molecular weight and the molecular weight distribution cannot be measured by the above method, there may be used the one having a melt viscosity and a polymerization degree that make it possible to form a resin layer by an ordinary melt-working method.

The glass transition temperature of the alicyclic olefin polymer may be suitably selected depending upon the use, but is usually not lower than 50° C., preferably, not lower than 70° C., more preferably, not lower than 100° C. and, most preferably, not lower than 125° C.

The aromatic polyether polymer that constitutes the curable composition is a polyether having an aromatic ring, and is usually obtained by reacting 2,6-di-substituted phenols such as 2,6-dimethyl phenol or 2,6-diphenylphenol with oxygen in the presence of a basic copper (II) salt such as a copper (II) amine complex. As the aromatic polyether polymer, there can be exemplified a polyphenylene ether and a modified polyphenylene ether. Among them, it is desired to use a modified polyphenylene ether having a small dielectric constant and a small dielectric tangent.

The ultraviolet ray absorbing agent constituting the curable composition used in the present invention is a compound exhibiting absorption in the ultraviolet-ray region. Concrete examples of the ultraviolet-ray absorbing agent include salicylic acid compounds such as phenyl salicylate, p-tert-butylphenyl salicylate and p-octylphenyl salicylate; benzophenone compounds such as 2,4-dihydroxybenzophenone, 2-hydroxy-4-methoxybenzophenone, 2-hydroxy-4-octoxybenzophenone, 2-hydroxy-4-dodecyloxybenzophenone, 2,2′-dihydroxy-4,4′-dimethoxybenzophenone, 2-hydroxy-4-methoxy-5-sulfobenzophenone, and bis(2-hydroxy-4-methoxybenzoylphenyl)methane; benzotriazole compounds such as 2-(2′-hydroxy-5′-methylphenyl)benzotriazole, 2-(2′-hydroxy-5′-tert-butylphenyl)benzotriazole, 2-(2′-hydroxy-3′,5′-di-tert-amylphenyl)benzotriazole, 2-[2′-hydroxy-3′-(3″,4″,5″,6″-tetrahydrophthalimidemethyl)-5′-methylphenyl]benzotriazole, 2,2-methylenebis[4-(1,1,3,3,-tetramethylbutyl)-6-(2H-benzotriazole-2-il)phenyl] and 2-[2-hydroxy-3,5-bis(α,α-dimethylbenzyl)phenyl]benzotriazole; benzoate compounds such as 2,4-di-tert-butylphenyl-3′,5′-di -tert-butyl-4′-hydroxybenzoate; cyanoacrylate compounds such as 2-ehtylhexyl-2-cyano-3,3′-diphenyl acrylate and ethyl-2-cyano-3,3′-diphenyl acrylate; hindered amine compounds such as bis(2,2,6,6-tetramethylpiperdinyl-4)sebacate; organometal compounds such as nickel-bis(octylphenyl)sulfide, [2,2′-thiobis(4-tert-octylphenolato)]-n-butylamine nickel, as well as zinc oxide, tin oxide, titanium oxide, calcium carbonate, and inorganic compounds such as silica and clay. Among them, it is desired to use the benzotriazole compounds from the standpoint of compatibility with the polymers having an annular structure and excellent stability at the time of curing by heating.

The amount of the ultraviolet ray absorbing agent is, usually, from 0.1 to 30 parts by weight and, preferably, from 1 to 10 parts by weight per 100 parts by weight of the insulating resin. when the amount of the ultraviolet ray absorbing agent is too small, the effect of the invention is not often exhibited. When the amount is too great, on the other hand, the electric insulating property is deteriorated.

The curable composition used in the present invention may, as required, be blended with other components. As the blending agent, there can be used, in addition to the above insulating resin, a soft polymer, a filler, a heat stabilizer, a weather-proofing agent, an anti-aging agent, a leveling agent, an anti-static agent, a slipping agent, an anti-blocking agent, an anti-fogging agent, a lubricant, a dye, a pigment, a natural oil, a synthetic oil, a wax, an emulsifier, a filler, a curing agent and a flame-retarding agent. The blending ratio is suitably selected within a range of not impairing the object of the present invention.

A preferred curable composition used in the present invention contains a curing agent and, particularly, a nitrogen-type curing agent. The nitrogen-type curing agent contains nitrogen atoms. The curing agent may be any one of the ionic curing agent, radical curing agent or the ionic and radical curing agent provided it contains nitrogen. It is, however, desired to use the ionic curing agent from the standpoint of insulation resistance, heat resistance, resistance against chemicals and compatibility with the insulating resin. It is, further, desired that the nitrogen-type curing agent used in the present invention does not contain a halogen element.

Examples of the nitrogen-type curing agent include aliphatic polyamines such as hexamethylenediamine, triethylenetetramine, diethylenetriamine and tetraethylenepentamine; alicyclic polyamines such as diaminocyclohexane, 3(4),8(9)-bis(aminomethyl)tricyclo[[5.2.1.0^{2,6}]decane, 1,3-(diaminomethyl)cyclohexane, diamine, isophoronediamine, N-aminoethylpiperazine, bis(4-amino-3-methylcyclohexyl)methane, and bis(4-aminocyclohexyl)methane; aromatic polyamines such as 4,4′-diaminodiphenyl ether, 4,4′-diaminodiphenylmethane, α,α′-bis(4-aminophenyl)-1,3-diisopropylbenzene, α,α′-bis(4-aminophenyl)-1,4-diisopropylbenzene, 4,4′-diaminodiphenylsulfone, metaphenylenediamine and metaxylylenediamine; polyamides such as nylon-6, nylon-66, nylon-610, nylon-11, nylon-612, nylon-12, nylon-46, methoxymethylated polyamide, polyhexamethylenediamineterephthalamide and polyhexamethyleneisophthalamide; isocyanates such as hexamethylenediisocyanate and toluylenediisocyanate; isocyanuric acid; triallylcyanurate; 1-allylisocyanurate, 1,3-diallylisocyanurate, 1,3-diallyl-5-benzylisocyanurate, triallylisocyanurate, 1-allyl-3,5-dibenzylisocyanurate; and isocyanurates such as 1-allyl-3,5-diglycidylisocyanurate, 1,3-diallyl-5-glycidylisocyanurate and triglycidylisocyanurate. Among them, it is desired to use the nitrogen-type curing agent containing a vinyl group and an epoxy group and, particularly, to use halogen-free isocyanurate type curing agents containing a vinyl group and an epoxy group, such as 1-allyl-3,5-diglycidylisocyanurate and 1,3-diallyl-5-glycidylisocyanurate.

The nitrogen-type curing agents may be used in one kind or in a combination of two or more kinds at a blending ratio of, usually, from 5 to 150 parts by weight, preferably, from 15 to 110 parts by weight and, more preferably, from 30 to 100 parts by weight per 100 parts by weight of the insulating resin.

It is desired that the curable composition used in the present invention contains a flame-retarding agent and, particularly, a phosphorus-type flame-retarding agent. The phosphorus-type frame-retarding agent is a phosphorus-containing compound having flame-retarding property. Examples of the phosphorus-type frame-retarding agent include phosphoric acid ester compounds such as triphenyl phosphate, tricresyl phosphate, trixylenyl phosphate, trimethyl phosphate, triethyl phosphate, tributyl phosphate, trioctyl phosphate, tributoxyethyl phosphate, octyldiphenyl phosphate, cresyldiphenyl phosphate, xylenyldiphenyl phosphate, resorcinylbis(diphenyl)phosphate, 2-ethylhexyldiphenyl phosphate, dimethylmethyl phosphate, triallyl phosphate, diethylbis(hydroxyethyl)aminomethyl phosphate, and condensed phosphoric acid ester; phosphoric acid, phosphonic acid, phosphinic acid, metaphosphoric acid, diphosphoric acid; inorganic phosphorus compounds such as monohydrate of sodium phosphinate, pentahydrate of sodium phosphonate, 2.5 hydrate of sodium hydrogenphosphonate, dodecahydrate of sodium phosphate, disodium hydrogenphosphate, dodecahydrate of disodium hydrogenphosphate, monohydrate of sodium dihydrogenphosphate, dihydrate of sodium dihydrogenphosphate, decahydrate of sodium phosphite, decahydrate of sodiumdiphosphate, disodium dihydrogendiphosphate, hexahydrate of disodium dihydrogendiphosphate, sodium triphosphate, sodium cyclo-tetraphosphate, potassium phosphinate, potassium phosphonate, potassium hydrogenphosphonate, potassium phosphate, dipotassium hydrogenphosphate, potassium dihydrogenphosphate, trihydrate of potassiumdiphosphate, potassium metaphosphate and red phosphorus; phosphate compounds such ammonium polyphosphate, melamine salt of polyphosphoric acid, sulfate of polyphosphoric acid, guanidine phosphate, and urea guanyl phosphate; phosphoric ester amide compounds such as diphenylphosphoric ester-2-propenylamide, diphenylphosphoric ester-2-hydroxyethylamide, diphenylphosphoric ester-di(2-hydroxyethyl)amide, diphenylphosphoric ester-di-2-cyanoethylamide, diphenylphosphoric ester-p-hydroxyphenylamide, diphenylphosphoric ester-m-hydroxyphenylamide, and diphenylphosphoric ester-cyclohexylamide; and amide phosphate compounds such as phenylphosphoric ester-di-N,N-phenylmethylamide and phenylphosphoric ester-di-N-cyclohexylamide. The amount of the phosphorus-type flame-regarding gent is usually from 1 to 100 parts by weight and, preferably, from 5 to 60 parts by weight per 100 parts by weight of the insulating resin. Among them, it is desired to use the phosphorus-type flame-retarding agent not containing a halogen element and, particularly, to use a phosphate compound not containing a halogen element and, more concretely, to use a melamine salt of polyphosphoric acid.

As the peroxides to be contained in the curable composition, there can be exemplified benzoyl peroxide, dichlorobenzoyl peroxide, dicumyl peroxide, di-tert-butyl peroxide, 2,5-dimethyl-2,5-(peroxide benzoate)hexyne-3,1,4-bis(tert-butylperoxyisopropyl)benzene, lauroyl peroxide, tert-butyl peracetate, 2,5-dimethyl-2,5-di(tert-butylperoxy)hexyne-3,2,5-dimethyl-2,5-di(tert-butylperoxy)hexane, tert-butyl perbenzoate, tert-butylperphenyl acetate, tert-butylperisobutylate, tert-butylper-sec-octoate, tert-butyl perpivalate, cumyl perpivalate, tert-butylperdiethyl acetate, methyl ethyl ketone peroxide, cyclohexanone peroxide, 1,1-bis(t-butylperoxy)3,3,5-trimethylcyclohexane, 2,2-bis(t-butylperoxy)butane, t-butylhydro peroxide, 2,5-dimethylhexane-2,5-dihydro peroxide, dicumyl peroxide, 2,5-dimethyl-2,5-di(t-butylperoxy)hexyne-3, α,α′-bis(t-butylperoxy-m-isopropyl)benzene, octanoyl peroxide, isobutyl peroxide and peroxy dicarbonate. Among these peroxides, it is desired to use those not containing a halogen element.

The amount of the peroxide is usually from 0.1 to 40 parts by weight and, preferably, from 1 to 20 parts by weight per 100 parts by weight of the insulating resin. When the amount of the peroxide lies within this range, the layers can be favorably laminated such as covering the wiring.

The curable composition containing the above-mentioned nitrogen-type curing agent, phosphorus-type flame-retarding agent and, as required, a peroxide, exhibits excellent flame-retarding property, insulating property and adhesiveness. Even when burned, the curable composition does not produce harmful substances such as halogen compounds and can, hence, be used as an insulating layer for the multi-layer circuit board, an insulating film among the semiconductor element layers, a solder resist, spacers for the liquid crystal display devices, cells and as an adhesive.

It is further desired to use a thiol compound and a silane compound as blending agents in order to improve the insulation resistance and the peel resistance. The thiol compound or the silane compound is blended in an amount of usually from 0.001 to 30 parts by weight and, preferably, from 0.01 to 10 parts by weight per 100 parts by weight of the insulating resin. When the amount is too, small, the insulation resistance and the peel resistance are hardly exhibited. When the blending amount is too great, the heat resistance and the resistance against chemicals tend to decrease.

The inner-layer board used in the present invention comprises an electrically insulating layer a and an electrically conducting circuit layer 1 formed on the surface thereof.

The electrically conducting circuit layer 1 constituting the inner-layer board is an electric circuit formed by an electric conductor such as an electrically conducting metal, and the circuit constitution may be the same as the one used for ordinary multi-layer circuit boards.

Concrete examples of the inner-layer board may include a printed wiring board, a silicon wafer board, etc. The inner-layer board has a thickness of, usually, from 50 μm to 2 mm, preferably, from 60 μm to 1.6 mm and, more preferably, from 100 μm to 1 mm.

There is no particular limitation on the material of the electrically insulating layer a constituting the inner-layer board provided it has an electrically insulating property. As the material of the electrically insulating layer a, there can be used, for example, a curable composition which is cured and containing an alicyclic olefin polymer, an epoxy resin, a maleimide resin, a (meth)acrylic resin, a diallyl phthalate resin, a triazine resin and a polyphenylene ether. The inner-layer board may further contain a glass fiber or a resin fiber for improving the strength.

The electrically insulating layer obtained by curing the above curable composition can be formed on the surface of the inner-layer board on which the electrically conducting circuit layer 1 is formed, by (I) applying a varnish comprising the curable composition and an organic solvent onto the board having the electrically conducting circuit layer, and curing a molded article that is obtained by removing the organic solvent by drying, or (II) overlapping and adhering a film or a sheet of the curable composition on the board having the electrically conducting circuit layer by the application of heat and pressure followed by curing. From the standpoint of maintaining smoothness of the electrically insulating layer and easily forming the multiplicity of layers, however, it is desired to obtain the laminate by the method (II).

There is no particular limitation on the method of molding the curable composition into a film or a sheet. According to the present invention, however, it is desired to form the film or the sheet by a solution casting method or a melt casting method. According to the solution casting method, a solution or a dispersion of the curable composition is applied onto a support member, and the solvent is removed by drying.

Examples of the solvent used for dissolving or dispersing the curable composition of the present invention include aromatic hydrocarbon solvents such as toluene, xylene, ethylbenzene and trimethylbenzene; aliphatic hydrocarbon solvents such as n-pentane, n-hexane and n-heptane; alicyclic hydrocarbon solvents such as cyclopentane and cyclohexane; halogenated hydrocarbon solvents such as chlorobenzene, dichlorobenzene and trichlorobenzene; and ketone solvents such as methyl ethyl ketone, methyl isobutyl ketone, cyclopentanone and cyclohexanone. These solvents may be used in one kind or in a combination of two or more kinds.

Among these solvents, it is desired to use a mixed solvent of a non-polar solvent such as an aromatic hydrocarbon solvent or an alicyclic hydrocarbon solvent and a polar solvent such as a ketone solvent from the standpoint of embedding of the fine wiring and inhibiting the evolution of bubbles. The ratio of mixing the non-polar solvent and the polar solvent can be suitably selected and is, usually, from 5:95 to 95:5, preferably, from 10:90 to 90:10 and, more preferably, from 20:80 to 80:20 in terms of the weight ratio.

The amount of using the solvent can be suitably selected depending upon the use, and is such that a solid concentration of a solution or a dispersion of the curable composition is usually from 5 to 70% by weight, preferably, from 10 to 65% by weight and, more preferably, from 20 to 60% by weight.

The curable composition may be dispersed or dissolved in the solvent according to a customary method such as stirring by using a stirrer and magnetic stirrer, or by using a high-speed homogenizer, a dispersion, a planetary stirrer, a biaxial stirrer, a ball mill or a three-roll mill.

As the support member used for the solution casting method, there can be used a resin film or a metal foil. As the resin film, there is usually used a thermoplastic resin film. Concrete examples include a polypropylene film, a polyethylene film, a polycarbonate film, a polyethylene terephthalate film, a polyethylene naphthalate film, a polyarylate film and a nylon film. Among these resin films, it is desired to use the polyethylene terephthalate film and the polyethylene naphthalate film from the standpoint of heat resistance, resistance against the chemicals and peeling after laminated. As the metal foil, there can be used, for example, a copper foil, an aluminum foil, a nickel foil, a chromium foil, a gold foil and a silver foil. From the standpoint of good electrically conducting property and cost, it is desired to use the copper foil and, particularly, an electrolytic copper foil and a rolled copper foil. Though there is no particular limitation, the thickness of the support member is usually from 1 μm to 150 μm, preferably, from 2 μm to 100 μm and, more preferably, from 3 μm to 50 μm.

As the method of application, there can be exemplified a dip coating method, a roll coating method, a curtain coating method, a die coating method or a slit coating method. The conditions for removing the solvent by drying can be suitably selected depending upon the kind of the solvent, the drying temperature being, usually, from 20 to 300° C. and, preferably, from 30 to 200° C., and the drying time being, usually, from 30 seconds to one hour and, preferably, from one minute to 30 minutes.

The film-like or sheet-like molded article has a thickness of, usually, from 0.1 to 150 μm, preferably, from 0.5 to 100 μm and, more preferably, from 1.0 to 80 μm. When it is desired to obtain the film or the sheet alone, the film or the sheet is formed on the support member and is, then, peeled off the support member.

To laminate the film or the sheet of the curable composition on the inner-layer board, the film or the sheet with the support member is so overlapped that the film or the sheet is in contact with the surface of the inner-layer board, and is adhered with the application of heat and pressure by using a pressing machine such as a press laminator, a press, a vacuum laminator, a vacuum press or a roll laminator. It is desired that the adhesion with the application of heat and pressure is conducted in vacuum in order to improve embedding of the wiring and to suppress the evolution of bubbles. The adhesion with the application of heat and pressure is conducted at a temperature of, usually, from 30 to 250° C. and, preferably, from 70 to 200° C., under a pressure of, usually, from 0.1 to 200 kg/cm² and, preferably, from 1 to 100 kg/cm² and for an adhesion time of, usually, from 30 seconds to 5 hours and, preferably, from one minute to 3 hours or the pressure is decreased down to, usually, from 760 mmHg to 0.01 mmHg and, preferably, from 300 mmHg to 0.1 mmHg.

The curable composition is cured usually by being heated. The curing temperature is suitably selected depending upon the kind of the nitrogen-type curing agent but is, usually, from 30 to 400° C., preferably, from 70 to 300° C. and, more preferably, from 100 to 200° C., and the curing time is, usually, from 0.1 to 5 hours and, preferably, from 0.5 to 3 hours. When the film or the sheet with the support member is to be laminated on the inner-layer board, the film or the sheet of the curable composition may be cured by heating with the support member being adhered thereto. Usually, however, the film or the sheet of the curable composition is cured by heating after the support member has been peeled off.

When the film or the sheet with the support member is laminated on the inner-layer board, on the other hand, the support member is all removed, and the film or the sheet is cured to obtain the electrically insulating layer b. When the support member is an electrically conducting metal foil, the metal foil is partly or all left and is utilized as the electrically conducting circuit layer 2.

Next, the layer of the curable composition that has been cured, i.e., the electrically insulating layer b, is irradiated with an ultraviolet-ray laser beam to form holes therein.

The ultraviolet-ray laser beam has an oscillation wavelength in the ultraviolet-ray region. The ultraviolet-ray region is usually from 180 nm to 380 nm, preferably, from 200 nm to 380 nm and, more preferably, from 300 nm to 380 nm.

Examples of the laser for obtaining the ultraviolet-ray laser beam include gas lasers such as of Ar, N₂, ArF, KrF, XeCL, XeF, He—Cd, and He—Ne; solid lasers such as of YAG, NdYAG, Nd glass and alexandrite; and a coloring matter laser using a coloring matter dissolved in an organic solvent. In particular, it is desired to use the YAG laser and the NdYAG laser capable of maintaining high-output energy, featuring long life and enabling the laser device to be maintained at a low cost. Harmonics of these lasers are favorably used having oscillation wavelengths in the ultraviolet-ray region. The laser harmonics are obtained by oscillating a laser beam (fundamental wave) of 1.06 μm from, for example, the YAG laser, passing the laser beam through two non-linear crystals (LBO crystals) arranged in parallel in the direction of an optical passage maintaining a predetermined gap to convert it into a THG beam (ultraviolet ray) of a wavelength of 0.355 μm through an SHG beam of a wavelength of 0.53 μm. A device for obtaining such a higher harmonic can be represented by a laser machining device disclosed in Japanese Unexamined Patent Publication (Kokai) No. 11-342485.

The laser beam can be irradiated continuously or intermittently. It is, however, desired that the laser is intermittently irradiated as a single pulse from the standpoint of preventing the occurrence of cracks. The number of times of irradiating the single pulses (number of shots) is usually from 5 to 100 times and, preferably, from 10 to 50 times. The machining time increases with an increase in the number of times of irradiation, and cracks tend to occur. The pulse period is usually from 3 to 8 kHz and, preferably, from 4 to 5 kHz.

The holes that are formed are used as through-holes and blind via-holes. The ratio of the inner diameter (d1) of the bottom of the hole and the inner diameter (d0) of the inlet (surface) of the hole (hole diameter ratio: d1/d0×100[%]) is, usually, not smaller than 40%, preferably, not smaller than 50% and, more preferably, not smaller than 65%. Here, d0 is, usually, from 10 to 250 μm and, preferably, from 20 to 80 μm. When the hole diameter ratio is great, defective conduction occurs little among the insulating layers, and the multi-layer circuit board exhibits a high reliability.

After the holes are formed, the electrically conducting circuit layer 2 can be formed on the surface of the electrically insulating layer b. The new electrically conducting circuit can be formed on the electrically insulating layer b by a plating method or a sputtering method. Prior to effecting the plating or sputtering, the surface of the electrically insulating layer b can be brought into contact with a solution of permanganic acid or chromic acid, or can be treated with a plasma to enhance the adhering force between the electrically insulating layer b and the electrically conducting circuit layer 2.

According to the present invention, the electrically insulating layers and the electrically conducting circuits can be newly stacked in any number of layers by using, as a new inner-layer board, the board obtained by forming the electrically insulating layer b and the electrically conducting circuit layer 2.

The multi-layer circuit board obtained by the method of the present invention can be used as a printed wiring board for mounting semiconductor elements such as CPUs and memories as well as any other mounting parts in the electronic equipment such as computers and cell phones. In particular, one having a fine wiring can be favorably used as a high-density printed wiring board for portable terminals used in high-speed computers and in high-frequency regions.

### EXAMPLES

The invention will now be concretely described by way of Examples and Comparative Examples. In the Examples, parts and percent are all by weight unless stated otherwise.

In the Examples, the evaluation was based on the methods described below.

(1) Molecular Weight.

Unless stated otherwise, the molecular weight was measured being calculated as a polystyrene by the gel permeation chromatography (GPC) using toluene as a solvent.

(2) Hydrogenation Ratio and Content of Maleic Acid Residue.

The hydrogenation ratio of unsaturated bonds to the mol number in the polymer of before being hydrogenated and the ratio (content of maleic acid residue) of mol number of (anhydrous) maleic acid residue to the total number of monomer units were measured based upon the ¹H-NMR spectrum.

(3) Glass Transition Temperature (Tg).

Measured according to the differential scanning calorimetric method (DSC method).

(4) Low Dielectric Characteristics.

Specific inductivity (ε) was measured in compliance with the method of measuring dielectric constant stipulated under JPCA-BU01, and samples having ε of not larger than 3.3 were evaluated to be ⊚, samples having ε of not smaller than 3.3 but not larger than 3.8 were evaluated to be ◯, samples having ε of not smaller than 3.8 but not larger than 4.0 were evaluated to be Δ, and samples having ε of not smaller than 4.0 was evaluated to be X.

(5) Insulating Property.

A comb-shaped electrode maintaining a gap of 50 μm among the wirings and having a wiring width of 50 μm was formed on the second electrically insulating layer of the multi-layer circuit board, and was left to stand under the conditions of saturated water vapor maintained at 120° C. in a state of applying a DC voltage of 50 V. After 300 hours have passed, the electric resistance was measured. The samples having electric resistances of not smaller than 10⁹ ohms and without being short-circuited were evaluated to be ⊚, the samples having electric resistances of not smaller than 10⁸ ohms but smaller than 10⁹ and without being short-circuited were evaluated to be ◯, the samples having electric resistances of smaller than 10⁸ and without being short-circuited were evaluated to be Δ, and the short-circuited samples were evaluated to be X irrespective of their electric resistance.

(6) Adhesiveness.

The multi-layer circuit board was treated under the conditions of saturated water vapor maintained at 121° C. for 100 hours, put through the checker adhesion testing in compliance with JIS K-5400, and was evaluated in compliance with JIS K-5400 on the following basis:

◯: 8 points or higher.

Δ: smaller than 8 points but not smaller than 4 points.

X: smaller than 4 points.

(7) Evaluation of Laser Cracks.

Cracks that occur at the time of laser beam machining were evaluated in a manner as described below. That is, 20 holes in the vertical direction×20 holes in the lateral direction, i.e., a total of 400 holes were formed by using a UV-YAG laser (device name: LAVIA-UV2000, manufactured by Sumitomo Juki Kogyo Co.) at an oscillation frequency of 4000 Hz maintaining a mask diameter of 0.64 mm, a via-hole surface of 40 μm, a via-hole bottom surface of 30 μm and a distance between the via-hole centers of 80 μm. Then, cracks of not smaller than 1 μm occurring in the insulating resin were measured by using an optical microscope. Those without cracks were evaluated to be ◯, those developing not less than one cracks but not more than 5 cracks were evaluated to be Δ, and those developing not less than 5 cracks were evaluated to be X.

(8) Evaluation of Laser Beam Machinability.

When the via-hole surface diameter is denoted by d0 and the via-hole bottom surface diameter by d1 with the mask diameter of 0.64 mm while using the UV-YAG laser (device name: LAVIA-UV2000, manufactured by Sumitomo Juki Kogyo Co.) at an oscillation frequency of 4000 Hz, the samples were evaluated to be ◯ when the number of times of irradiation was not larger than 50 times for the via-hole diameter ratio given by the formula (d1/d0)×100 (%) to exceed 70%, the samples were evaluated to be Δ when the number of times of irradiation was not smaller than 50 times but was not larger than 150 times, and the samples were evaluated to be X when the number of times of irradiation was not smaller than 150 times.

### Example 1

An 8-ethyl-tetracyclo[4.4.0.1^{2,5}.1^{7,10}]-dodeca-3-ene was open-ring polymerized and was, then, hydrogenated to obtain a hydrogenated polymer having a number average molecular weight (Mn)=31,200, a weight average molecular weight (Mw)=55,800 and Tg=about 140° C. The hydrogenation ratio of the obtained polymer was not smaller than 99%.

100 parts by weight of the thus obtained polymer, 40 parts of a maleic anhydride and 5 parts of a dicumyl peroxide were dissolved in 250 parts of a t-butylbenzene, and were reacted at 140° C. for 6 hours. The obtained solution of the reaction product was poured into 1000 parts of an isopropyl alcohol, and the reaction product was coagulated to obtain a maleic acid-modified hydrogenated polymer. The modified hydrogenated polymer was dried in vacuum at 100° C. for 20 hours. The modified hydrogenated polymer possessed molecular weights of Mn=33,200, Mw=68,300 and Tg of 170° C. The content of the maleic acid residue was 25% by mol.

100 Parts of the modified hydrogenated polymer, 50 parts of a 1,3-diallyl-5-glycidylisocyanurate, 5 parts of a dicumyl peroxide, 30 parts of a melamine salt of polyphosphoric acid having an average particle diameter of 3 μm, 5 parts of a 2-[2-hydroxy-3,5-bis(α,α-dimethylbenzyl)phenyl]benzotriazole, 0.03 parts of a benzylphenyl imidazole and 20 parts of a polybutadiene (trade name: Nisseki Polybutadiene B-700, manufactured by Nihon Sekiyu Kagaku Co.) were dissolved in a mixed solvent comprising 170 parts of a xylene and 110 parts of a cyclopentanone to prepare a varnish thereof.

By using a die coater, the varnish was applied onto a square polyethylene naphthalate film (carrier film) having a side of 300 mm and a thickness of 40 μm, and was, then, dried in a nitrogen oven at 100° C. for 10 minutes to obtain a dry film having a resin thickness of 35 μm on the carrier film.

The above dry film with the carrier film was overlapped on both surfaces of a board of which both surfaces have been lined with copper (the board having micro-etched surfaces and a thickness of 0.8 mm and being obtained by impregnating a glass cloth with a varnish containing a glass filler and a halogen-free epoxy resin) in a manner that the resin surfaces were on the inside, and was adhered by using a vacuum laminator while reducing the pressure down to 1 mmHg, at a temperature of 130° C., exerting a force of 5 kgf/cm² for 10 minutes to obtain a laminate plate. The thus obtained laminate plate was taken out from the laminator, and the polyethylene naphthalate film only was peeled off. The laminate plate was then heated in a nitrogen oven at 150° C. for 120 minutes to cure the resin and to thereby form an insulating layer. The insulating layer of the obtained laminate plate was evaluated for cracks and for the laser beam machinability. The evaluated results were as shown in Table 1.

Further, the dry film with the carrier film was overlapped on both surfaces of a board on which had been formed through-holes of a diameter of 0.2 mm by plating and an electrically conducting circuit layer having a wiring width of 75 μm, a gap among the wirings of 75 μm and a wiring layer thickness of 18 μm (the board being obtained by impregnating a glass cloth with a varnish containing a glass filler and a halogen-free epoxy resin) in a manner that the resin surfaces were on the inside, and was adhered by using a vacuum laminator while reducing the pressure down to 1 mmHg, at a temperature of 130° C., exerting a force of 5 kgf/cm² for 10 minutes to obtain a laminate plate. The thus obtained laminate plate was taken out from the laminator, and the polyethylene naphthalate film only was peeled off. The laminate plate was then heated in a nitrogen oven at 150° C. for 120 minutes to cure the resin and to thereby form an insulating layer.

Via-holes of a predetermined size for inter-layer connection were formed in the insulating layer of the obtained laminate plate by using a UV-YAG laser (device name: LAVIA-UV2000, manufactured by Sumitomo Juki Kogyo Co.) at an oscillation frequency of 4000 Hz and a mask diameter of 0.64 mm. Next, the laminate plate was washed with water, dried and was exposed to an argon plasma of 1000 watts for 10 minutes.

Next, the laminate plate was subjected to the copper sputtering to form a thin copper film of a thickness of 0.1 μm on the wall surfaces of via-holes and on the whole surfaces of the laminate plate.

A commercially available photosensitive dry film was stuck onto the surface of the laminate plate with the application of heat and pressure and was exposed to light while intimately adhering a mask of a predetermined pattern thereon, followed by developing to obtain a resist pattern. Next, an electrolytic copper plating was effected onto the portions where the resist has not been formed to thereby form an electrolytic copper-plated film having a thickness of 18 μm. Then, the resist pattern was removed by peeling using a peeling solution, and the thin sputtered copper film that had been concealed under the resist-formed portions was removed by using a mixed solution of cupric chloride and hydrochloric acid to thereby form a wiring pattern. Finally, the annealing was conducted at 170° C. for 30 minutes to obtain a circuit board.

0.1 part of a 2-dibutylamino-4,6-dimercapto-s-triazine was dissolved in 100 parts of an isopropyl alcohol to obtain a solution for pre-treating the electrically conducting layer. The circuit board obtained above was immersed in the solution for pre-treating the electrically conducting layer at room temperature for one minute and was, then, dried at 90° C. for 15 minutes. By using the thus treated circuit board as the above core board, the insulating layer and the electrically conducting layer were formed repetitively in the same manner as described above to obtain a multi-layer circuit board having a total of six layers on both surfaces thereof. The adhesiveness, insulating property and dielectric constant were evaluated to be as shown in Table 1.

### Example 2

A board for evaluating laser cracks, a board for evaluating laser beam machinability and a multi-layer circuit board were obtained in the same manner as in Example 1 but without using the melamine salt of polyphosphoric acid. The results were evaluated to be as shown in Table 1.

### Example 3

10 Parts of a 2,6-dimethylphenol was dissolved in a mixed solvent of 100 parts by volume of toluene and 5 parts by volume of an N,N,N′,N′-tetramethylethylenediamine, and 10.8 parts by volume of an n-butyllithium (1.54 mols/liter, hexane solution) was added to carry out the reaction in a nitrogen atmosphere at room temperature for one hour. Then, the reaction product was cooled down to −70° C. and 2 parts of a propargyl bromide was added with stirring. The mixture was poured into a large amount of methanol to precipitate the polymer which was, then, filtered and was washed with methanol three times to obtain a white powdery propargyl group-substituted polyphenylene ether polymer. The substitution ratio of the propargyl group with ¹H-NMR was found to be 5%.

100 Parts of the propargyl group-substituted polyphenylene ether polymer, 50 parts of a 1,3-diallyl-5-glycidyl isocyanurate, 5 parts of a dicumyl peroxide, 40 parts of a melamine salt of polyphosphoric acid having an average particle diameter of 3 μm and 5 parts of a 2-[2-hydroxy-3,5-bis(α,α-dimethylbenzyl)phenyl]benzotriazole, were dissolved in 200 parts of a trichloroethylene to obtain a varnish thereof. By using the varnish, a board for evaluating laser cracks, a board for evaluating laser beam machinability and a multi-layer circuit board were obtained in the same manner as in Example 1. The results were evaluated to be as shown in Table 1.

### Comparative Example 1

A board for evaluating laser cracks, a board for evaluating laser beam machinability and a multi-layer circuit board were obtained in the same manner as in Example 1 but without using the 2-[2-hydroxy-3,5-bis(α,α-dimethylbenzyl)phenyl]benzotriazole. The results were evaluated to be as shown in Table 1.

### Comparative Example 2

A board for evaluating laser cracks, a board for evaluating laser beam machinability and a multi-layer circuit board were obtained in the same manner as in Example 2 but without using the 2-[2-hydroxy-3,5-bis(α,α-dimethylbenzyl)phenyl]benzotriazole. The results were evaluated to be as shown in Table 1.

### Comparative Example 3

A board for evaluating laser cracks, a board for evaluating laser beam machinability and a multi-layer circuit board were obtained in the same manner as in Example 3 but without using the 2-[2-hydroxy-3,5-bis(α,α-dimethylbenzyl)phenyl]benzotriazole. The results were evaluated to be as shown in Table 1.

TABLE 1

| | Dielectric | Insulation | | Laser | Laser |
|---|---|---|---|---|---|
| | constant | property | Adhesion | crack | machining |
| Example 1 | ⊚ | ⊚ | ⊚ | ◯ | ◯ |
| Example 2 | ⊚ | ⊚ | ⊚ | ◯ | ◯ |
| Example 3 | ⊚ | ◯ | ◯ | ◯ | ◯ |
| Comp. Ex. 1 | ⊚ | ⊚ | ⊚ | ◯ | X |
| Comp. Ex. 2 | ⊚ | ⊚ | ⊚ | X | X |
| Comp. Ex. 3 | ⊚ | ◯ | ◯ | ◯ | X |

Industrial Applicability.

By using the curable composition of the present invention, there is easily obtained a multi-layer circuit board having a low dielectric constant, large adhesiveness and excellent insulating property. Further, the curable composition of the invention can be favorably machined with a laser beam and can be excellently produced. In forming via-holes maintaining a narrow pitch by using a laser beam, in particular, there occur no cracks. By using the curable composition, therefore, it is made possible to fabricate a multi-layer circuit board of a high density for mounting semiconductor elements such as CPUs and memories as well as other mounting parts in the electronic equipment such as computers and cell phones.

Further, the multi-layer circuit board of the present invention can be made of a so-called non-halogen curable composition. In this case, even when burned, the multi-layer circuit board does not produce toxic gas due to halogen and, therefore, is environmentally desirable.

1. A method of producing circuit boards by laminating, on an inner-layer board, a curable composition containing an insulating resin and an ultraviolet-ray absorbing agent, curing said composition, and forming holes in the cured composition by the irradiation with an ultraviolet-ray laser beam.

2. A method of production according to claim 1, wherein the insulating resin is an alicyclic olefin polymer, an aromatic polyether or an epoxy resin.

3. A method of production according to claim 1, wherein the curable composition further contains a curing agent.

4. A method of production according to claim 1, wherein the curing agent is a nitrogen-type curing agent.

5. A method of production according to claim 4, wherein the nitrogen-type curing agent contains a vinyl group and an epoxy group.

6. A method of production according to claim 1, wherein the curable composition further contains a phosphorus-type flame-retarding agent.

7. A curable composition containing an alicyclic olefin polymer or an aromatic polyether polymer, a benzotriazole compound as an ultraviolet-ray absorbing agent, and a nitrogen-type curing agent.

8. A curable composition according to claim 7, wherein the benzotriazole compound is a 2-[2-hydroxy-3,5-bis(α,α-dimethylbenzyl)phenyl]benzotriazole.

9. A curable composition according to claim 7 or 8, wherein the nitrogen-type curing agent is the one containing a vinyl group and an epoxy group.

10. A curable composition according to claim 7, further containing a phosphorus-type flame-retarding agent.
